(19) United States
(12) Patent Application Publication
(10) Pub. No.: US 2011/0197821 A1
(43) Pub. Date: Aug. 18, 2011

(54) WILD ANIMAL PROTECTION DEVICE

(76) Inventor: GEORGE JOSEPH SANKER, Brighton, MA (US)

(21) Appl. No.: 12/704,558

(22) Filed: Feb. 12, 2010

(51) Int. Cl. A01M 29/00

(52) U.S. Cl. 119/174

(57) ABSTRACT

The present invention is a portable and compact inflatable or expandable wildlife protection device, to be held by a person in the presence of a dangerous wild animal, such as a grizzly bear, to make said person look bigger and intimidating to the wild animal, thus preventing the animal from attacking.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The present invention involves a portable device to be carried for protection by hikers, photographers, rangers, and other persons in wilderness and other areas populated by potentially dangerous wildlife, such as grizzly bears.

The protections available today to persons walking in such wilderness areas consist of firearms, knives, noise-makers, and bear pepper spray. There are serious limitations to these protections however.

Authorized persons, such as park rangers, may carry firearms, but most people do not, and cannot pursuant to National Park and other rules and regulations. Further, there are risks associated with firearms in an encounter with wild animals, in that a wounded animal may become more aggressive and dangerous.

Noise-makers are helpful in alerting animals to one's presence, thus reducing the risk of a dangerous encounter resulting from a surprised, and thus possibly panicked, animal. However, they may be of no use against an animal that knows of the presence of the person but decides to attack.

Bear spray has a short range of approximately 10-20 yards, and said range and the placement of the spray can be compromised by the wind. A charging grizzly bear that gets to within 10 yards of a person would be frightening, to say the least, and probably unstoppable.

A knife requires actual combat with the attacking animal.

Thus, while these technologies may help, they are far from perfect, and may not prevent a close and dangerous encounter.

### SUMMARY OF THE INVENTION

The present invention is a portable and compact inflatable or expandable wildlife protection device, to be held by a person in the presence of a dangerous wild animal, such as a grizzly bear, to make said person look bigger and intimidating to the wild animal, thus preventing the animal from attacking.

### BRIEF DESCRIPTION OF THE DRAWINGS

FIG. 1 is a sketch of a hiker in a wilderness area, from the point of view directly behind the hiker, looking at an aggressive grizzly bear, with the invention device deployed;

FIG. 2 is a sketch of a hiker in a wilderness area, from the point of view directly behind an aggressive grizzly bear, looking at the hiker, with the invention device deployed.

### DETAILED DESCRIPTION OF THE INVENTION

The present invention is a lightweight device for protection that can be carried by any person walking or otherwise traveling in wilderness or other areas populated by potentially dangerous wild animals. The purpose of this invention is to prevent serious injury or death to a human being caused by a wild animal attack. Another purpose is to prevent injury or death that might be inflicted by law enforcement or other governmental authorities upon a wild animal involved in an attack upon a human being.

The present invention is a portable and compact inflatable or expandable device, which can be deployed quickly to inflate or expand into the appearance of the upper body and head of a large, tall, fierce human being or creature, and then held by a person against the front of his/her upper body as he/she faces a threatening wild animal. This invention is designed to fool a potentially threatening wild animal into thinking that a person it encounters is larger and more ferocious than a normal human being, thus causing the wild animal to not attack.

Wild animals assess the size of a potential opponent, or prey, in deciding whether to attack. Thus, a person confronted by a potentially dangerous or threatening wild animal who can make himself/herself appear bigger, taller and more intimidating to said animal, may be able to prevent the animal from attacking.

While most wild animals will not attack people, there are always exceptions, and there have been many instances of serious injury and death to persons attacked by grizzly bears, bison, mountain lions, elk, and other large animals.

Presently, with the exception of a firearm, which is prohibited in national parks and other protected ecosystems, the only protection that people traveling in wilderness areas have against attack by large, wild animals, is pepper spray, knives, and noise-makers. Each of these devices has serious limitations and will not always protect against an attack. Pepper spray and knives can only be deployed in very close proximity to the attacking animal. Noise-makers are generally carried to alert a wild animal to one's presence, but will probably be useless against an aggressive animal.

The present invention is designed for use in conjunction with and as a complement to these other protection devices, and may eliminate the need to deploy these other devices. It would provide an additional layer of protection, and would probably be the first line of defense, in that it could be implemented effectively from a greater distance away from the wild animal. Thus if this present invention causes the animal to move away, or become less aggressive or non-aggressive, there would be no need to use a firearm, other weapon, or bear spray.

Experienced hikers, photographers, hunters, and law enforcement personnel who travel in wilderness areas populated by grizzly bears for example, always carry bear spray in the event of an attack.

Nobody wants to be within 10-20 yards of an aggressive grizzly bear however, but bear spray can only be deployed when the animal is that close. The present invention could be deployed effectively when the wild animal is still a considerable and safe distance away, perhaps even 100-200 yards away.

The present invention would be made with light-weight materials, already in the marketplace, that could be inflated or expanded in one of several different types of existing technologies. These include self-inflation or the release of air into the device, as is in an inflatable camp mattress, vest, balloon, or rubber raft, or expansion of the device, as in a tent, umbrella or oriental fan. There are many products in the marketplace today, consisting of lightweight materials, which are inflatable or expandable.

The present invention would include an artistic rendering of the face and head, and perhaps arms or claws, of a fierce-looking being or monster on the side of the device facing the wild animal. This drawing or painting or other rendering might include large eyes and large, dangerous-looking fangs and claws.

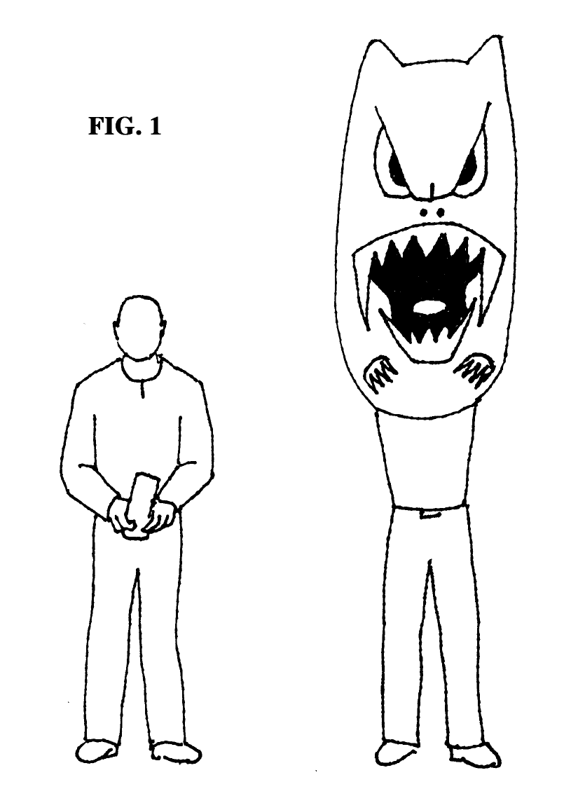

FIG. 1 is a sketch of a hiker in a wilderness area, from the point of view directly behind the hiker, looking at an aggressive grizzly bear, with the invention device deployed;

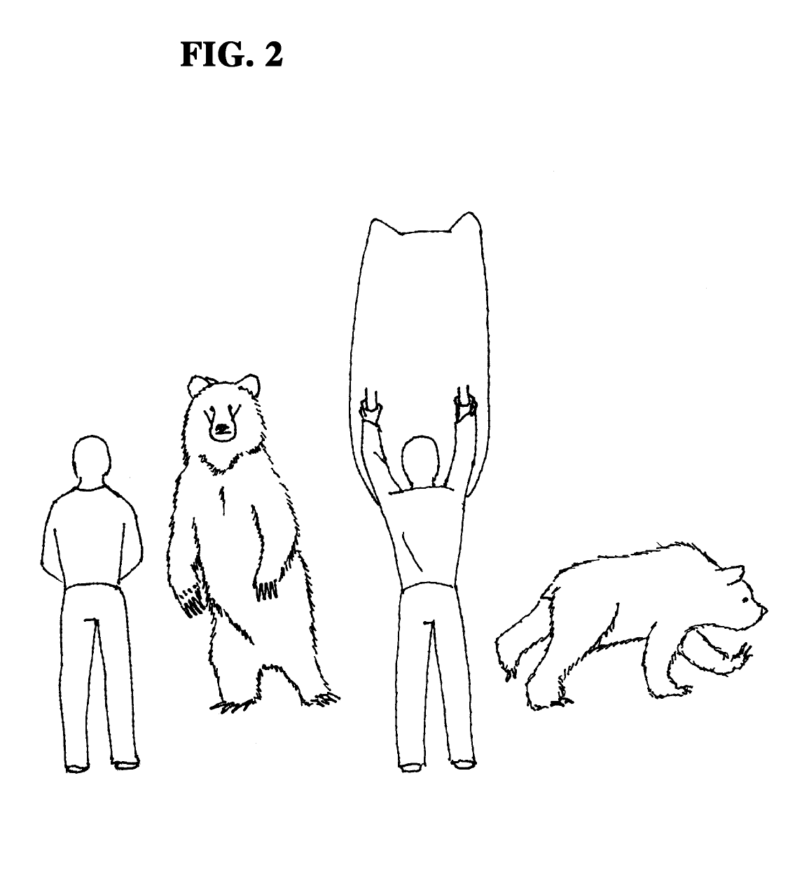

FIG. 2 is a sketch of a hiker in a wilderness area, from the point of view directly behind an aggressive grizzly bear, looking at the hiker, with the invention device deployed.

1. I claim a lightweight, compact, and portable device to be carried by persons traveling in wilderness or other areas populated by large, wild animals, that can be inflated, to fool an aggressive wild animal into thinking that a person deploying the device is a tall, large, frightening, and intimidating being, so as to prevent an attack by said wild animal.

2. A device according to claim 1, which would be constructed with existing light-weight materials, that could be inflated using existing technologies, as in self-inflating camp mattresses and pillows, floating vests, balloons, rafts, boats, toys and furniture.

3. I claim a lightweight, compact, and portable device to be carried by persons traveling in wilderness or other areas populated by large, wild animals, that can be expanded, to fool an aggressive wild animal into thinking that a person deploying the device is a tall, large, frightening, and intimidating being, so as to prevent an attack by said wild animal.

4. A device according to claim 3, which would be constructed with existing light-weight materials, that could be expanded using existing technologies, as in tents, umbrellas, or hand-held fans.
